(19) United States
(12) Patent Application Publication
(10) Pub. No.: US 2013/0056304 A1
(43) Pub. Date: Mar. 7, 2013

(54) Elevator Without Counterweight With a Cogged Belt and Pulley

(71) Applicants: Jose Luis Blanco Sanchez, Madrid (ES); Borislav Tzvetkov Martinov, Madrid (ES)

(72) Inventors: Jose Luis Blanco Sanchez, Madrid (ES); Borislav Tzvetkov Martinov, Madrid (ES)

(21) Appl. No.: 13/605,332

(22) Filed: Sep. 6, 2012

(30) Foreign Application Priority Data
Sep. 7, 2011 (ES) 201100834

(51) Int. Cl. B66B 11/08

(52) U.S. Cl. 187/255

(57) ABSTRACT

An elevator without a counterweight and with a cogged belt and pulley has deflecting pulleys arranged above and below the car, respectively. In the upper portion of the hoistway there is, on one hand, a hanger for the cogged belt and, on the other hand, a machine having a cogged driving pulley. In the lower portion of the hoistway, there is a tensioner associated with a deflecting pulley. Another deflecting pulley is provided. The pulley has a diameter greater than 100 mm, is made of a single part, and has helical cogs. The machine has an associated deflecting pulley and non-slip rollers. The cogged belt is made of transparent polyurethane and a textile mesh covering the cogged portion. In addition to a uniform and well balanced translation of the car, an effective reduction of noise levels is achieved.

### CROSS-REFERENCE TO RELATED APPLICATIONS

This application claims the priority, under 35 U.S.C. §§119 and 371, of Spanish patent application No. 201100834 filed Sep. 7, 2011; the prior application is herewith incorporated by reference in its entirety.

### STATEMENT REGARDING FEDERALLY SPONSORED RESEARCH OR DEVELOPMENT

Not Applicable

### FIELD OF THE INVENTION

The present invention lies in the field of elevators. The present disclosure relates to an elevator without counterweight and with a cogged belt and pulley and, particularly, to the elements and distribution thereof for the purpose of moving the car without there being sliding between the belt and the driving pulley, with a minimum car weight, and with a great use of the elevator hoistway.

The present invention is characterized in the design and configuration both of the drive and the elements thereof, with achieving a reduction of noise levels generated, with a uniform, well-balanced translation of the car, and with a high comfort level.

As a result of the present invention, moving the car without the belt sliding with respect to the pulley is achieved, even with very low belt tension in the rope passing under the car. In this aspect, the invention provides improved safety. Counterweight elimination offers the possibility of making anoptimum use of the ground surface of the elevator hoistway for transporting the load. Finally, use of the cogged belt allows a reduction in the diameter of the pulleys in comparison with a cable of the same strength, which has a circular cross-section.

Therefore, the present invention is encompassed within the scope of elevators without counterweight, and additionally, among those elevators that have a cogged pulley and belt as a transmission.

### BACKGROUND OF THE INVENTION

International Patent Publication WO 2008/000886 to Mustalahti et al. describes an elevator without a counterweight and which uses a flat cable or cable having a circular cross-section, using a tensioner that provides a variable tension according to the information given to it by a load cell located in the car to assure the traction and to keep the tension ratio in the two corresponding ropes T1/T2. Because this system does not have cogged pulleys and belts, it does not assure the traction in the entire path and, additionally, it also does not limit the belt movement and compensate for the elongation of the belts subjected to tension over time without keeping the tension T1/T2, the use of a tensioner and of a load cell being necessary.

International Patent Publication WO2004/094287 and WO2004/094289 to Siewert et al. describe the same hoistway configuration as International Patent Publication WO 2008/000886, but the tensioner is not “variable” according to the load of the car. These systems always provide a constant tension.

The last two patents do not have cogged pulleys and belts as a traction device with the advantages derived therefrom, of being the ideal way to assure the traction, being oriented towards the cables, therefore keeping the tension T1/T2 is necessary.

International Patent Publication WO2004/067429 to Aulanko et al. describes an elevator with a more complex deflecting pulley configuration (suspension 10:1) to maintain the traction by the tension ratio T1/T2 without the need of a counterweight. This device is essentially envisaged for cables having a circular cross-section.

International Patent Publication WO2004/041704 to Mustalahti et al. describes an elevator without counterweight, but driven by round cables. In comparison, International Patent Publication WO2005/087647 to Mustalahti et al. discloses a method for installing elevators of this type by using pre-assembled structures. Both cases show the difficulty of needing to keep the tension T1/T2. On the other hand, because cogged pulleys and belts are not used, maintaining the traction is not assured.

Until now cars must have a minimum weight to assure the friction traction capacity between the flat cable or belt and the driving pulley. If the minimum weight is not present, sliding between the flat cable or belt and the driving pulley would occur. This means that the car and, accordingly, the counterweight, become more expensive because more material is needed. This drawback is solved by patent publication ES 2280579 T3, which describes a traction device with a counterweight made by a cogged pulley on which there is meshed a cogged belt, which, although prevents the sliding between the belt and the pulley, has aspects that are susceptible to being improved.

All those described are systems for moving the car of an elevator, in several cases with a cogged belt and in other cases with a flat belt, however, they have some aspects which are susceptible to being improved such as those explained below.
On one hand, regardless of whether or not the belt is cogged, the belts do not have any measures that allow for identification when they have suffered from any damage, particularly in the steel reinforcement cables embedded in the belt.
On the other hand, and particularly in the traction systems with a cogged belt, the noise level generated is relatively high. This is, therefore, an aspect susceptible to being improved.
Also, lack of precision in the meshing between the cogged pulley and the cogged belt occurs in the cogged belt systems and, particularly, those having a cog configuration in two rows disposed in a V, as a result of the process of manufacturing cogged pulleys, because they are manufactured in two attached halves. This lack of precision results in an increase of the noise level.
Another difficulty or technical aspect susceptible to improvement is the fact that the car does not translate in the most well-balanced way possible, it being convenient to avoid horizontal components on the deflecting pulleys.
Furthermore, in the elevator systems having a counterweight or in which the machine is not located on the projection of the ceiling of the car, the best use is not made of the hoistway because it is subjected to the constructive conditions of the elevator. A fact that results in a lack of balance in the translation of the car.
Another difficulty susceptible of being improved is the difficulty of preventing the shaft of the driving pulley from not receiving the entire load.
Also, in the state of the art, the elevators without a counterweight lack measures to limit the belt movement and compensate for the elongation of the belts subjected to tension over time.

Thus, a need exists to overcome the problems with the prior art systems, designs, and processes as discussed above.

### SUMMARY OF THE INVENTION

The invention provides an elevator without a counterweight and with a cogged belt that overcomes the hereinafore-mentioned disadvantages of the heretofore-known devices and methods of this general type and that provide such features by overcoming the drawbacks described, i.e.,:
which prevents the sliding between the cogged cable and the cogged pulley;
which has measures to allow a quick identification of possible damage suffered in the reinforcement of the cogged or non-cogged belt;
which, in the case of cogged belts, reduces the noise level generated;
which the cogged pulley and cogged belt meshes with the greatest precision possible;
the car translates in the most well balanced way possible;
which makes the best use of the elevator hoistway;
which the shaft of the cogged pulley does not receive all the force or torque; and
having measures to limit the belt movement and compensate for the elongation of the belts subjected to tension over time.

In addition to the improvements listed in this section, the elevator design is simplified by making it less expensive and simpler without needing to keep the tension ratio to maintain the traction and, for this purpose, used cogged belts and pulleys with non-slip rollers.

Ultimately, the noise levels generated in the translation are reduced, and a well-balanced and uniform translation of the car is achieved by developing, for such purposes, an arrangement and configuration such as those described below.

The inventive elevator without a counterweight and with a cogged belt has a particular configuration and configuration of the drive elements, i.e., of the traction machine, of the cogged belt and of the associated measures, such as the deflecting pulleys, a hanger of one end of the cogged pulley and the tensioner of the other end of the cogged belt.

The car moves vertically through the hole of a building known as the elevator hoistway, where the car is intended for transporting people or goods. The car is guided along the hoistway by a group of guides. The car is suspended from a cogged belt system. The assembly is driven by a machine located in the upper portion of the hoistway. The belt system is such that, in a car raising movement, the length of cable drawn in by the machine of the upper portion of the hoistway is returned to the lower portion of the hoistway.

By dividing the elevator belt system, there are two ropes in which the tension of the belts is different. The rope passing under the car is tension-free and the slightest tension that it has is due to its own weight and to that caused by a belt tensioner. The rope suspending the car owes its tension to the weight of the car itself and to the useful load.

It is necessary to place a tensioner at one end of the belt system for limiting the belt movement, which otherwise would crash against the hoistway itself or against the car. A tensioner is also necessary to compensate for the elongation of the cables subjected to tension over time.

The car guides are vertically supported on the bottom of the hoistway. The horizontal forces on the guides are transferred to the walls of the hoistway. The horizontal forces on the guides occur when the center of gravity of the car-plus-load are horizontally shifted from the center of suspension of the car (crossed coordinates of the guide).

It is important to suitably choose the position of the guides and center of suspension with respect to the geometric center of the car. Insofar as the horizontal guiding forces are low, the size of the guide will be small and, thus, there is more space available in the hoistway for the useful load.

The fact of supporting the machine to a large extent on one of the guides allows transferring the weight of the entire system to the floor of the hoistway. Therefore, the walls of the building do not have to support the weight of the elevator assembly.

Unlike a conventional elevator, there is no counterweight or mass balancing the weight of the car. Because the counterweight is eliminated, more space is available to make the car larger and increase the useful load of the car.

On the other hand, the use of cogged belts enables movement of the car without sliding, even with a very low belt tension in the rope passing under the car. In an elevator with counterweight, the cars (and the counterweights) must have a minimum weight to maintain the traction capacity assured by the very friction between cable and driving pulley. Ecause the principle of the belts is not based upon friction, but on the meshing of the cogs, it is already possible to reduce the weight of the empty car as much as possible and, therefore, making the car less expensive by using less material.

It is possible to achieve a great use of the dimensions of the hoistway to thus make the car as big as possible by placing the machine in the projection of the car ceiling, eliminating the counterweight, and adjusting the size of the guides.

The use of deflecting pulleys in the belt hangers moves the belt lashings out of the car trajectory. Consequently, the height of the hoistway and of the clearance can be reduced.

Cogged belts are more flexible than round steel cables. Therefore, the deflecting pulleys and the driving pulley of the machine have a smaller diameter (i.e., they are more compact). The torque of the machine is directly proportional to the diameter of the driving pulley. The machine could be made with a smaller section to take advantage of the space intended as clearance.

As a result of using a cogged pulley and belt, the sliding between both portions, and, therefore, the need of the car and counterweight to have a minimum weight which results in reducing the size of the drive, is prevented.

To achieve a quick identification of the possible damage suffered in the cogged belt reinforcement, embedding the steel reinforcement cables in transparent polyurethane is proposed. Thus, if one of the cables of the reinforcement breaks, in addition to being able to visually identify the breakage thereof, an inner bubble facilitating the identification is produced.

To reduce the noise level generated, constructive variations of those systems made until now are proposed. On one hand, the diameter of the driving pulley is increased for reducing the number of revolutions, preventing vibrations and, therefore, noise. On the other hand, and to achieve the aforementioned purpose of reducing the noise levels, the cogs of the driving pulley are helical, which assures a uniform meshing with the cogged belt and not a discontinuous meshing, as has been occurring with the pulleys with non-helical cogs. This further results in a prolongation of the service life of the cogged belt.

Furthermore, on the cogged face of the cogged belt there is disposed a textile mesh absorbing and improving the meshing between the pulley and the belt, thereby reducing the noise level.

Furthermore and for the purpose of reducing the noise levels, in the case of cogged belts with the cogs disposed in two rows of inclined cogs forming a V, the cogged pulley is made of a single part because, until now, pulleys were made in two parts assembled to one another. Therefore, any minimum deviation in the coupling of the two portions of the cogged pulley results in a lack of precision in the meshing and, therefore, to a higher noise level. Manufacturing in a single part, therefore, assures a perfect meshing between the cogged pulley and belt and prevents the possible deviations that have been occurring up until now.

To achieve the most well-balanced possible translation of the car, a vertical attack of the cogged belt with respect to the pulley has been sought using, to that end, a deflecting pulley integrated with the machine, which prevents any horizontal component in the driving pulleys, and therefore in the car and counterweight, a fact which happens in patent ES 2280579 T3.

The use of a deflecting pulley integrated with the machine further reduces the forces to those which the shaft of the driving pulley would be subjected in the case of not having the deflecting pulley proposed herein, and therefore, reduces the constructive requirements of the shaft.

Furthermore and for the purpose of achieving the most well-balanced possible translation of the car, anti slip wheels are associated with the driving pulley, which wheels are placed with their axes perpendicular to the tangent of the entry and exit points of the cogged belt with respect to the cogged pulley.

The car guides centrally disposed in relation to the center of masses of the car assembly also collaborate in the well-balanced translation of the car.

Finally, to maintain the tension of the belt and to absorb elongation that occurs during the car movement, the cogged belt has, at one of its ends, a tensioner device preventing this effect, and, therefore, the vibrations that may be produced in the belt during the elevator operation.

Therefore, with the constructive improvements proposed herein, two technical effects are basically achieved. On one hand, the reduction of noise level and, on the other hand, a well-balanced and uniform translation of the car, the constructive variants described being necessary and that some of them cooperate in the two purposes described, in addition to achieving derived additional technical effects.

Although the invention is illustrated and described herein as embodied in an elevator without a counterweight and with a cogged belt, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a side elevational view of an exemplary embodiment of an elevator with a configuration of cogged belts and deflecting pulleys;

FIG. 2 is a top plan view of the elevator of FIG. 1;

FIG. 3 is a fragmentary, perspective view of an exemplary embodiment of a machine assembly of the elevator of FIG. 1 together with an exemplary embodiment of the cogged pulley and cogged belt;

FIG. 4 is a fragmentary, perspective view of the cogged belt and pulley of FIG. 3;

FIGS. 5A to 5C are fragmentary, enlarged front and side elevational views of the cogged belt of FIG. 3;

FIG. 6 is a fragmentary, cross-sectional view of the cogged belt of FIG. 3 illustrating constructive features of the cogged belt;

FIG. 7 is a fragmentary, front elevational view of the machine assembly of FIG. 3 together with non-slip rollers of the cogged belt and the deflecting pulley;

FIG. 8 is a fragmentary, perspective view of elements forming part of an exemplary embodiment of a tensioner of the cogged belt mounted on the bottom of the hoistway;

FIG. 9 is a fragmentary, perspective view of a belt tensioner assembly of the elevator of FIG. 1 located in the elevator hoistway;

FIG. 10 is a fragmentary, perspective view of an exemplary embodiment of a hanger for the cogged belt of FIG. 3;

FIG. 11 is a fragmentary, side elevational view of an exemplary embodiment of a hanger assembly formed by a belt lashing together with the deflecting pulley;

FIG. 12 is a cross-sectional view of an exemplary embodiment of a deflecting pulley illustrating constructive features of the deflecting pulley; and

FIG. 13 is a perspective view of an exemplary embodiment showing integration of the deflecting pulley with the traction machine.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

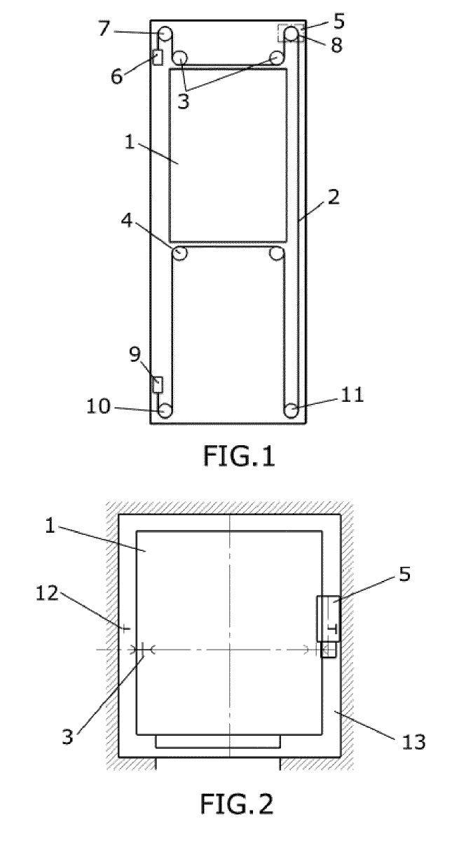

Described now are exemplary embodiments of the present invention. Referring now to the figures of the drawings in detail and first, particularly to FIG. 1, there is shown a first exemplary embodiment of the architecture or geometry of cogged pulleys and a belt assembly of the elevator 1 distributed as set forth in the following text. Deflecting pulleys 3 and 4 are disposed above and below the car 1. The deflecting pulleys 3 are disposed above the car, whereas the deflecting pulleys 4 are disposed below the car 1. In the upper portion of the hoistway 13, on one hand, is a hanger 6 for a cogged belt 2, a deflecting pulley 7 associated with the hanger 6 also being depicted, and, on the other hand, there is a machine 5, together with a cogged driving pulley 8 associated with the machine 5. In the lower portion of the hoistway, on one hand, a tensioner 9 is associated with a deflecting pulley 10 and, on the other hand, there is disposed a deflecting pulley 11.

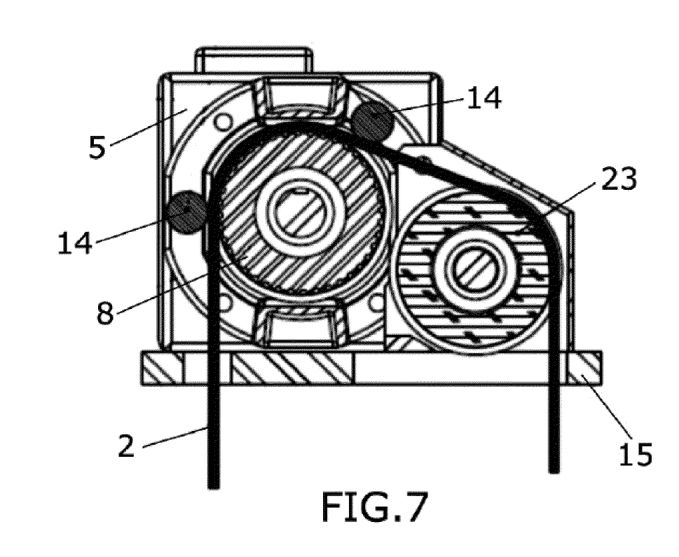

As is depicted, it can be observed that the cogged belt 2 starts from the hanger 6 and the associated deflecting pulley 7, passes through the upper pulleys 3 of the car 1, followed by the cogged pulley 8 and the deflecting pulley 23 (FIG. 7) of the machine 5, going to the bottom of the hoistway 1 until reaching the deflecting pulley of the hoistway 11, continuing through the lower pulleys 4 of the car 1 to finally end in the tensioner 9 and its associated deflecting pulley 10.

The load is suspended from the cogged belts, which are the traction elements replacing the conventional steel cable. The lifting is achieved as a result of meshing the cogs of the belt and those of the pulley, which, according to the shape thereof, can create the traction necessary for lifting the load. Therefore, dependency of the elevator operation on the friction forces between the cable and the driving pulley is eliminated.

The elevator hoistway 13 and the maximum use thereof can be observed in FIG. 2, as a result of a suitable configuration of the guides 12, the machine 5, and the deflecting pulleys. As can be observed, the guides 12 are centrally disposed with relation to the center of masses of the car assembly.

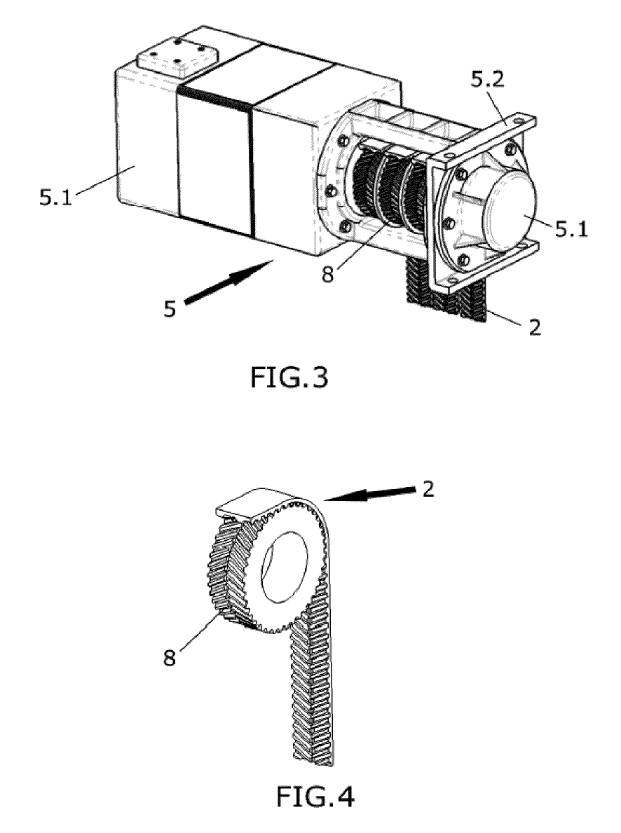

FIG. 3 shows the machine 5 for applying the traction on the cogged belt 2, the association of the machine 5 with a cogged pulley 8, and, in turn, the association of a cogged belt 2 with the latter being able to be observed.

The machine 5 has a brake 5.1, which is mounted either on the rear portion or on the front portion on the support 5.2. At least one cogged traction pulley 8 is disposed on the shaft of the machine, which, in a possible exemplary embodiment, may be two cogged pulleys. The pulleys are flanked by discs or flanges that do not allow the belt to come off from its operating position.

How the cogged belt 2 meshes with a cogged pulley 8, which is generally manufactured from metal in a single part and provided with helical cogs placed in a staggered formation with a channel in the center, whereas the cogs of the cogged belt are straight, can be seen in the perspective view of FIG. 4. This constructive form assures a perfect meshing of the pulley with the cogged belt, which results in a reduction of the noise level generated.

The diameter of the pulley is greater than about 100 mm, the cogs that it has are helical, with a passage between about 7 mm and 9 mm, both facts resulting in less vibration and noise. The width of the driving pulley is greater than the width of the cogged belt and it is self-centering, which, in a possible exemplary embodiment, the driving pulley is about 1 mm wider than the cogged belt.

As a result of the described features, an optimum operating speed is achieved, in which the rotation speed is not excessive, such as it would be with a pulley having a smaller diameter, and, therefore, the vibrations and noise are very low.

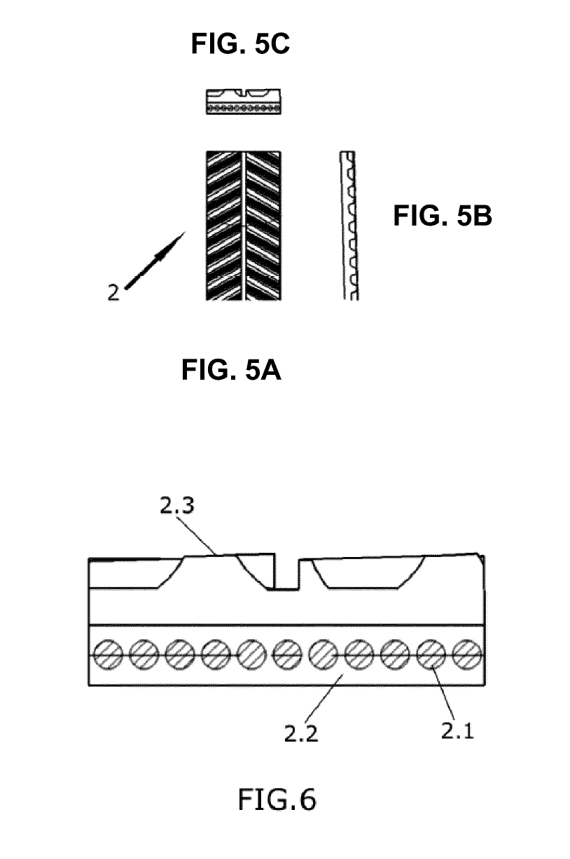

As shown in FIGS. 5A to 5C, the cogged belt 2 has two portions attached to one another by extrusion, which are a plastic portion and several steel cords embedded in the plastic portion. The plastic portion has two faces, a flat face and another cogged face. The cogged portion is formed by inclined cogs placed in a staggered formation. The cogs form an angle of about 120°. The passage between the cogs is comprised between about 7 and 9 mm. The width of the belt can be of different measurements depending on the power and the load to be transmitted. As observed in FIG. 6, the belt 2 has three elements, which include the transparent polyurethane 2.2, steel reinforcement cables 2.1 embedded in the transparent polyurethane 2.2, and a textile mesh 2.3, disposed to cover the cogged portion. The textile mesh 2.3 improves the operation and the comfort level by increasing the coupling smoothness when moving. Therefore, the vibration and noise levels are improved. Whereas the transparent polyurethane allows a visual inspection of the steel reinforcement cables embedded in the polyurethane.

The thickness of the cogged belt with cogs is about 4 to 6 mm, the non-cogged portion has a thickness less than about 3 mm.

All the elements forming part of the elevator, particularly the cogged belt and pulley, adopt high safety coefficients preventing the breakage of the pulley or belt cogs. Driving in both directions in any direction is, thus, assured. Uncontrolled movement typical for a cable elevator caused by an unbalance between the stress of the two braches or by the lack of adherence are prevented.

It can be observed in FIG. 7 that the machine 4 has at least two non-slip rollers 14 preventing the belt 2 from coming off and are assembled such that their centers of rotation are perpendicular to the tangent of the entry and exit points of the cogged belt with respect to the cogged pulley. The distance between the non-slip rollers 14 and the pinions or cogged pulleys 9 is sufficient so that the belt passes freely in a well-meshed manner, but also prevents the cogs of the belt from coming off the cogs of the pinion.

Traction in both directions is, thus, assured, eliminating the risk of traction loss.

The machine 5 driving the traction system is mounted on a base 15. This base 15 transmits the forces both to the car guide 12 and to the walls of the elevator hoistway.

The machine 5 and its base 15 are located in the upper portion of the hoistway in the projection of the car. When the car 1 is in its upper most position, the machine 5 and its base 15 are at a distance from the car ceiling. All the above enables a maximum use of the elevator hoistway because the machine does not represent a limitation to maximize the car area. In other words, for several existing hoistway dimensions, it is possible to transport a greater number of passengers or objects at once.

It is important to highlight that the traction machine 5 has an associated deflecting pulley 23 improving the operation of the shaft as it does not receive all the load. Furthermore, non-slip rollers 14 associated with the machine 5 prevent the cogs of the belt from coming off from those of the pinion or pulley. This, in combination with the use of a cogged belt with a cogged pulley, assures the traction throughout the entire path.

On the other hand, as a result of the vertical attack of the cogged belts with respect to the deflecting pulley and the driving pulley of the machine, the horizontal component attempting to tip the car, creating a lack of comfort and greater wear in the friction clamps, as well as a lack of uniformity and balance in the translation of the car, is eliminated.

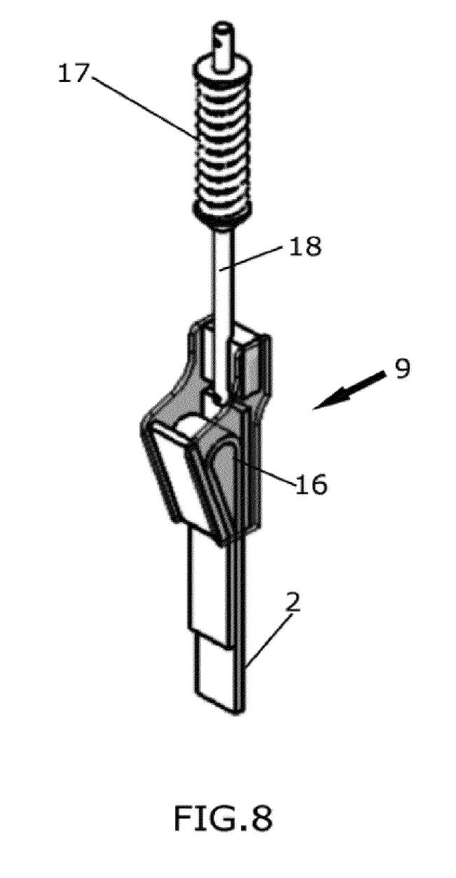

FIG. 8, where the elements forming part of the tensioner mounted on the bottom of the hoistway are shown, shows the cogged belt lashing by a wedge 16, associated with a regulating rod 18, which, in turn, has a spring 17 mounted thereon at its upper end. This spring 17 has several functions. On one hand, it absorbs the loads of the impact transmitted by the belts and, on the other, it keeps the cogged belts 2 with the same tension to prevent the premature failure of some of them due to poor tension distribution. Each belt lashing has a system for regulating the length of the terminal. Therefore, the tension of each of the belts can be balanced.

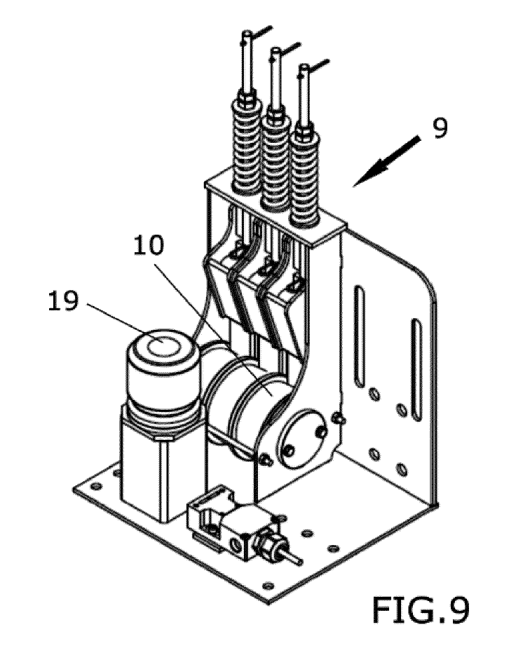

The tensioner 9 together with the deflecting pulley 10 and a damper 19 can be observed in FIG. 9. The deflecting pulleys in the lower area of the hoistway are secured to the car guide 12 by a metal structure. This structure is fixed both below the car guide and to the floor and wall of the hoistway.

Like the upper belt hanger, the deflecting pulley of the hanger allows bringing the car deflecting pulley below the position of the tensioner closer. This allows a reduction in the height of the hoistway.

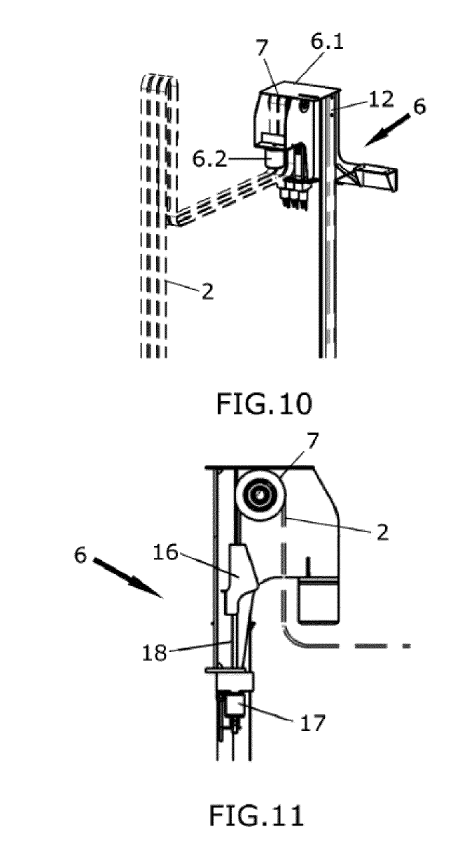

The hanger 6 for cogged belts 2 is observed in FIG. 10, where a metal structure 6.1, which supports the lashings of the belts and transmits the tension of the cogged belts to the car guide 12, can be seen. A damper 6.2 located in the car, which will impact against the metal structure of the hanger if the car goes beyond the end of the path, is shown.

The guide 12 is centered with respect to the geometric axis of the elevator hoistway.

FIG. 11 shows the assembly of the hanger 6 for cogged belts having elements for lashing the cogged belt 2, associated with a deflecting pulley 7.

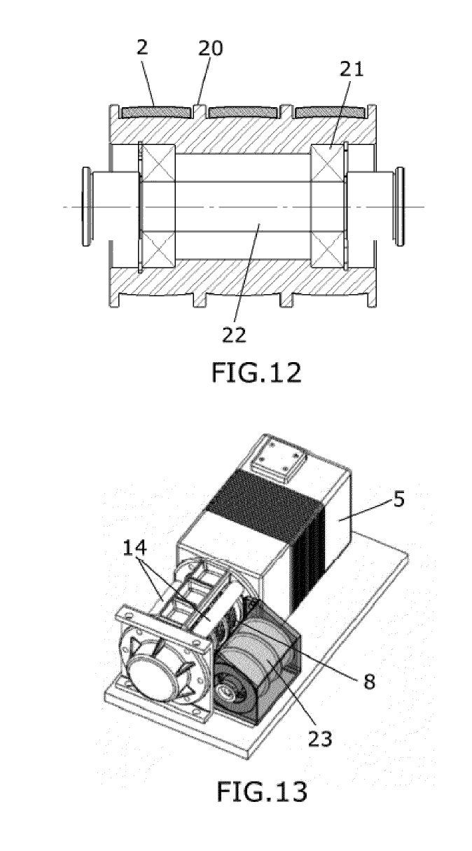

FIG. 12 shows the features of the deflecting pulleys, which can made of plastic; the deflecting pulleys are mounted on a shaft 22, at the ends of which there are bearings 21. Each of the pulleys has its own channellings separated by a flange 20, the channellings having a convexity or an outwardly dished shape for the purpose of centering the belt in the channelling without the need of bordering with the flanks of the channelling, thereby eliminating the wear of the sides of the belt.

Finally, the integration of a deflecting pulley 23 with the traction machine 5 is observed in FIG. 13, achieving, on one hand, the reduction of tension in the shaft of the pulley 8, and therefore, the constructive requirements of the shaft, and, on the other hand, the elimination of the horizontal components in the driving pulleys, resulting in a well-balanced and uniform translation of the car.

Having sufficiently described the nature of the present invention as well as a way of carrying it out to practice, it must be stated that it may be carried out into practice within its essentiality in other embodiments differing in detail from that indicated by way of example, which embodiments will also achieve the protection sought provided that the essential principle is not altered, changed or modified.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A counterweight-free elevator, comprising:
an elevator car moveable in an elevator hoistway and having a ceiling;
at least one cogged belt having:
a belt width;
a geometry with two faces including a flat face and a cogged face formed by inclined cogs placed in a staggered formation;
two portions attached to one another by extrusion, the two portions including a plastic portion and steel cords embedded in the plastic portion; and
three elements including transparent polyurethane, steel reinforcement cables embedded in the transparent polyurethane, and a textile mesh covering the cogged face;
first deflecting pulleys respectively disposed above and below the elevator car and operable to guide the at least one cogged belt;
at least one cogged driving pulley operable to drive the at least one cogged belt, being made of a single part defining a central groove, being self-centering, and having:
a pulley width greater than the belt width;
a diameter of at least 100 mm; and
helical cogs;
at least one of discs and flanges flanking the at least one cogged driving pulley;
a machine being disposed at an upper portion of the hoistway and located at a projection of the ceiling of the elevator car, the machine having:
the at least one cogged driving pulley;
a second deflecting pulley operable to guide the at least one cogged belt; and
at least two non-slip rollers preventing the at least one cogged belt from coming off therefrom and being operatively associated with the second deflecting pulley;
a hanger and an associated third deflecting pulley operable to guide the at least one cogged belt, the hanger and the third deflecting pulley disposed at the upper portion of the hoistway;
a tensioner and an associated fourth deflecting pulley disposed at the lower portion of the hoistway;
a fifth deflecting pulley disposed at the lower portion of the hoistway and operable to guide the at least one cogged belt.

2. The counterweight-free elevator according to claim 1, wherein the machine has:
a support;
a rear portion;
a front portion;
a brake mounted either at the rear portion or at the front portion on the support.

3. The counterweight-free elevator according to claim 1, wherein:
the elevator car has at least one car guide;
the elevator hoistway has walls; and
the machine is mounted on a base transmitting forces both to the car guide and to the walls of the elevator hoistway.

4. The counterweight-free elevator according to claim 2, wherein:
the elevator car has at least one car guide;
the elevator hoistway has walls; and
the machine is mounted on a base transmitting forces both to the car guide and to the walls of the elevator hoistway.

5. The counterweight-free elevator according to claim 1, wherein the non-slip rollers have centers of rotation and are assembled to position the centers of rotation perpendicular to a tangent of entry and exit points of the at least one cogged belt with respect to the at least one cogged driving pulley.

6. The counterweight-free elevator according to claim 3, which further comprises a metal structure fixed both below the car guide and to a floor and a wall of the hoistway, the fourth and fifth deflecting pulleys in the lower portion of the hoistway being secured to the car guide by the metal structure.

7. The counterweight-free elevator according to claim 3, wherein:
the at least one cogged belt has at least one lashing; and
the hanger for the at least one cogged belt has a metal structure supporting the lashing and transmitting tension of the cables to the car guide.

8. The counterweight-free elevator according to claim 3, which further comprises a support fixed at least to one of the car guide, a bottom of the hoistway, and a ceiling of the hoistway, the deflecting pulleys:
being mounted on the support;
having a belt tensioner and a damper;
being made of plastic; and
having channellings separated by a flange, the channellings having one of a convexity and a outwardly dished shape.

9. The counterweight-free elevator according to claim 1, wherein:
a thickness of a cogged portion of at least one cogged belt is 4 mm to 6 mm; and
a thickness of a non-cogged portion of the at least one cogged belt is less than 3 mm.

10. The counterweight-free elevator according to claim 1, wherein the at least one cogged driving pulley has helical cogs with a passage therebetween of approximately 7 mm and 9 mm and with a width approximately 1 mm greater than the belt width.

11. The counterweight-free elevator according to claim 1, wherein the elevator car has at least one car guide, and which further comprises a metal structure fixed both below the car guide and to a floor and a wall of the hoistway, the fourth and fifth deflecting pulleys in the lower portion of the hoistway being secured to the car guide by the metal structure.

12. The counterweight-free elevator according to claim 1, wherein:
the elevator car has at least one car guide;
the at least one cogged belt has at least one lashing; and
the hanger for the at least one cogged belt has a metal structure supporting the lashing and transmitting tension of the cables to the car guide.

13. The counterweight-free elevator according to claim 1, wherein the elevator car has at least one car guide, and which further comprises a support fixed at least to one of the car guide, a bottom of the hoistway, and a ceiling of the hoistway, the deflecting pulleys:
being mounted on the support;
having a belt tensioner and a damper;
being made of plastic; and
having channellings separated by a flange, the channellings having one of a convexity and a outwardly dished shape.
